(19) United States
(12) Patent Application Publication
(10) Pub. No.: US 2022/0388016 A1
(43) Pub. Date: Dec. 8, 2022

(54) SEPARATOR DISC, SEPARATOR DISC PACKAGE, CENTRIFUGE CONTAINING THE SEPARATOR DISC PACKAGE AND METHOD FOR PRODUCING THE SEPARATOR DISC

(71) Applicant: GEA MECHANICAL EQUIPMENT GMBH, Oelde (DE)

(72) Inventors: Adam-Michael HADAMIK, Dortmund (DE); Kathrin QUITER, Drensteinfurt (DE); Stephan FRIEDS, Buchholz (DE)

(21) Appl. No.: 17/776,732

(22) PCT Filed: Nov. 9, 2020
(86) PCT No.: PCT/EP2020/081493

§ 371 Date: May 13, 2022

(30) Foreign Application Priority Data
Nov. 14, 2019 (DE) 10 2019 130 796.1

(51) Int. Cl. B04B 7/14; B04B 1/08

(52) U.S. Cl. CPC B04B 7/14; B04B 1/08; B33Y 80/00

(57) ABSTRACT

A separator disc for a centrifuge, such as for a separator, is provided. The separator disc is designed to be arranged in a separator disc stack in the interior of a drum of the centrifuge in order to separate a material mixture. The separator disc has a truncated cone shell-like main part produced from a blank in a forming method and has an inner surface, an outer surface, and at least one functional element applied thereon. The at least one functional element is produced using an additive manufacturing method.

### BACKGROUND AND SUMMARY OF THE INVENTION

Exemplary embodiments of the present invention relate to a separator disc, a package of such separator discs, a centrifuge containing such a separator disc package, and to a method of manufacturing such a separator disc.

Separator discs for centrifuges, such as separators, usually have spacers by means of which the individual separator disc in a stack of separator discs is positioned at a distance from the adjacent separator disc. For hygienic reasons, it is required that the spacers—e.g., in the form of tabs—and the separator disc be connected to each other with as few gaps as possible.

In this case, the geometry of the spacers and their positioning on the separator disc should be as variable as possible. Common geometries of the spacers are, for example, linear, straight, curved, meandering or point-shaped.

Usually, the basic geometry of a separator disc is produced by a forming process. Known forming processes for the production of a separator disc are, for example, spin forming or flattening, as described, for example, in DE 11 2006 002 309 B4 or in EP 2 556895 B1.

Spot welding is usually used as the joining method for fastening the spacers to the separator disc, but this can leave gaps between the separator disc and the respective spacer.

In centrifuges for pharmaceutical applications, spacers are therefore also circumferentially welded on the separator disc with a laser to avoid possible gaps between the separator disc and the spacer (see e.g., DE 40 360 71 C1).

The disadvantage here is the complex welding process. Furthermore, the heat input resulting from the welding process can release forming stresses in the separator disc, which can lead to the separator disc warping as a result of the welding process.

Also known from the prior art are separator discs in which the spacers are introduced into the separator disc by a further forming process so that an integral separator disc is produced. Examples of this are EP 3 315 203 B1, EP 3 315 204 B1, EP 3315 205 A1 and DE 19705704 C1.

The disadvantage here is that an individual forming die is required as a negative mold for a forming process for each spacer geometry per separator disc design and size. This is necessary because both the number and arrangement of the spacers on the respective separator disc and their geometry and height cannot be varied in a single forming die, or only with considerable effort. Furthermore, such a forming process can also only produce spacers that taper outwards, as they would otherwise be impossible to remove from the forming die.

Another disadvantage is that the separator disc and the spacers are made of the same material due to the manufacturing process.

Furthermore, US 2018/0008990 A1 is known from the prior art, in which a separator disc produced by 3D printing and a separator disc package produced entirely in one piece by 3D printing and other parts of a separator produced by 3D printing are disclosed.

It remains to be seen whether such integral separator discs or integral separator disc packages, which are produced entirely by 3D printing, can permanently withstand the high centrifugal forces that prevail in an operating centrifuge.

Accordingly, exemplary embodiments of the present invention are directed to at least partially eliminate the disadvantages of the prior art.

Accordingly, a separator disc is provided for a centrifuge, in particular for a separator, wherein the separator disc is intended to be arranged in a separator disc stack in a drum interior of a drum of the centrifuge for separating a heterogeneous mixture of substances, such as e.g., a flowable suspension or a flowable emulsion, wherein the separator disc has a frustoconical shell-like base body, which is produced from a blank in a forming process and has an inner surface and an outer surface and at least one functional element applied thereto, wherein the at least one functional element is produced by an additive manufacturing process or is produced by additive manufacturing.

In additive manufacturing or an additive manufacturing process, material is applied layer by layer to create a three-dimensional structure. Physical or chemical hardening or melting processes take place during the build-up.

The invention thus creates a separator disc which, on the one hand, uses as a base body a base body formed with advantageously proven technology that permanently withstands the high centrifugal forces prevailing in a centrifuge in operation and, on the other hand, provides at least one functional element—such as one or more spacers and/or a coating or a layer with special properties—on the separator disc that can be freely designed topologically, geometrically and in terms of material over a wide range and is therefore advantageous.

In a preferred embodiment variant of the invention, it is provided that the additive manufacturing process is a 3D printing process. The 3D printing process advantageously offers large degrees of freedom with regard to the topology, the geometry, and in the choice of material when designing the functional elements.

In a further preferred embodiment variant of the invention, it is provided that the functional element has at least two spacers. According to the invention, spacers in particular can be designed variably or with large degrees of freedom. In addition, cost-intensive forming tools for forming separator discs with differently designed spacers can be dispensed with.

It is advantageous if the separator discs and the spacers are made of the same material, in particular the same metal. However, according to another option, it may also be useful that the separator disc material and the spacer material are not made of the same material or are made of different materials. Possible materials for this are carbon or graphite. Likewise, it may be useful, for example, that the separator disc is made of metal, but the spacers are made of other metal or of a non-metallic material, such as an (electrically) insulating material, such as non-conductive plastic, synthetic resin, or non-conductive ceramic. This makes it possible, for example, to produce a centrifuge with particularly defined properties.

According to an advantageous embodiment, the spacers are connected to the base body without gaps. In this way, hygienic requirements for the centrifuge can be met simply and without additional effort.

It is also advantageous if the spacers are arranged on an outer surface and/or an inner surface of the base body of a separator disc. If spacers are arranged on both the outer surface and the inner surface of the base body, the two adjacent separator discs can be designed without spacers. This opens up new design possibilities and can also result in cost savings in the production of separator discs for a centrifuge.

The cross-sectional geometry of the spacers is largely freely selectable and can be optimized with regard to the respective application. For example, the spacers can be trapezoidal, frustoconical, rectangular, rectangular with rounded corners, triangular, conical, semi-elliptical or semi-oval, or according to another geometry that can be described mathematically.

Furthermore, the cross-sectional geometry of the spacers can be designed symmetrically or asymmetrically.

Furthermore, the geometry of the spacers on a separator disc can vary, so not all spacers on a separator disc have to be designed with the same geometry.

It may further be provided that the spacers each extend along a uniform or respective different or patterned mathematically describable curve(s) on the base body.

Furthermore, the spacers may be arranged in uniform pitch or in non-uniform pitch or variable pitch or in repeating—i.e., regular-pitch patterns or in non-repeating—i.e., irregular-pitch patterns on the circumference of the base body.

In a further preferred embodiment variant of the invention, the spacers are designed in the form of elongated tabs or webs arranged in each case symmetrically to and along a generatrix M or generatrix-parallel. This results in a proven and advantageously simple geometry of the spacers.

Alternatively, the spacers can also be in the form of point-shaped or circular tabs. This may result in only small contact areas between two separator discs, so that a flow field between the separator discs is advantageously little influenced by the spacers.

In a further alternative, the tabs may be spaced apart by spaces/gaps of equal length between each tab. Further, the tabs and/or gaps may be of different lengths and/or the gaps may vary in size from tab to tab. The length of the tab and/or the gap can easily and thus advantageously influence the flow conditions between the separator discs.

In a further preferred embodiment variant of the invention, the functional element is a hydrophilic layer, which is applied to the base body with or without spacers, either in areas or completely. Alternatively, the functional element can also be a lipophilic layer. In this way, the properties of the separator discs can be further advantageously influenced, for example, when centrifuging milk.

According to exemplary embodiments of the invention there is a separator disc stack for a centrifuge—in particular for a separator—having a plurality of separator discs according to the invention. The stack can consist only of separator discs according to the invention, but it can optionally have further separator discs not according to the invention (e.g., those without spacers and/or without coatings).

According to exemplary embodiments of the invention there is a method for producing a separator disc, wherein the method according to the invention comprises the following method steps of:
a) providing a blank for the base body of the separator disc, a forming machine, and a unit for carrying out an additive manufacturing process;
b) forming the blank into the base body on the forming machine; and
c) producing at least one functional element by the 3D printing unit.

The forming machine and 3D printing unit can be designed separately or can be unified in one structural unit.

The method according to the invention creates a separator disc which, on the one hand, uses a base body formed with advantageously proven technology that permanently withstands the high centrifugal forces prevailing in a centrifuge in operation and, on the other hand, provides at least one functional element—such as, for example, several spacers and/or a coating or a layer with special properties—on the separator disc that can be freely designed topologically, geometrically, and in terms of material over a wide range and is therefore advantageous.

In a preferred embodiment variant of the method according to the invention, the forming machine is a spinning machine. As a result, the forming process leading to the base body of the separator disc is implemented with a proven technology that advantageously makes do with few or very simple tools. It is advantageous if the unit for implementing an additive manufacturing process is a 3D printing unit.

It is equally advantageous if the 3D printing unit is mounted on a Tool Center Point (TCP) of an industrial robot. This also allows large separator discs to be printed for which the usual machine dimensions of a 3D printer are too small.

In a further preferred embodiment variant of the method according to the invention, the blank of the base body is made of a metallic material, preferably steel. This creates a base body that can safely withstand the high centrifugal forces that occur during operation of the centrifuge.

### BRIEF DESCRIPTION OF THE DRAWING FIGURES

In the following, the invention is described in more detail by means of exemplary embodiments with reference to the figures. The invention is not limited to these exemplary embodiments but can also be implemented in other ways or equivalently within the scope of the claims, wherein:

FIG. 1: shows schematic diagram of a centrifuge in full section;

FIG. 2: shows a spatial view of a separator disc according to the invention with short, elongated spacers;

FIG. 3: shows a half sectional view of the separator disc of FIG. 2;

FIG. 4: shows a spatial view of a separator disc according to the invention with long elongated spacers;

FIG. 5: shows a half sectional view of the separator disc of FIG. 4;

FIG. 6: shows a spatial view of a separator disc according to the invention with point-shaped spacers;

FIG. 7: shows a half sectional view of the separator disc of FIG. 6.

### DETAILED DESCRIPTION

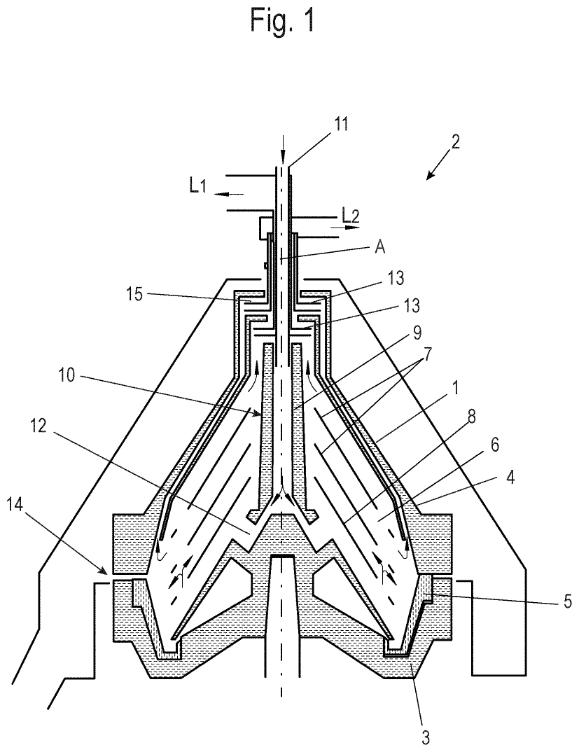

FIG. 1 shows a rotatable drum 1 of a centrifuge 2, which in this case is designed as a separator with a vertical axis of rotation A. In addition to the drum 1, the centrifuge 2 can—in a manner known per se—also have further components—not all of which are shown here—such as a control computer, a drive motor for rotating the drum, a hood, a frame, a solids trap, etc. The centrifuge 2 is designed as a separator with a vertical rotation axis A.

The drum 1, which is rotatable by a self-driven and rotatably mounted drive spindle, is preferably—but not necessarily—designed for continuous operation—i.e., continuous and not batchwise processing of a product.

The drum 1 consists of a lower part 3 and an upper part 4. A piston slide 5 may be inserted in the lower part 3.

In the drum, here in the internally conical or here even double-conical drum 1, a separator disc stack 7 consisting of several separator discs 8 is arranged in a drum interior 6.

The separator discs 8 can be arranged on a distributor shaft 9 of a distributor 10 or can be mounted on the distributor shaft 9 coaxially to the axis of rotation A. A feed tube 11 is used to supply a product to be processed. The feed pipe 11 is designed here as a stationary element that does not rotate during operation. It extends concentrically to the axis of rotation A into the drum 1.

According to FIG. 1, in a preferred—but not mandatory—embodiment, it projects into the drum 1 from above, but it can also extend into the drum 1 from below. A flowable product to be processed is fed through the feed pipe 11. The product emerging from the free end of the feed pipe 11 flows into radially extending distributor channels 12 of the distributor 10 and is co-rotated or accelerated in the circumferential direction therein as a result of the rotations of the rotating drum 1.

The distributor channels 12 open into the drum interior 6 with the separator disc stack 7. In the drum interior 6—also called the centrifugal chamber—a product is clarified from solids and separated into one, two, or more liquid phases of different density. One or more outlets for liquid phases are used to discharge the at least one liquid phase L1, here purely by way of example two liquid phases L1 and L2.

The liquid draining radially inwards from the separator disc stack 7 flows into a peeling disc chamber 15, which rotates with the drum 1 and is formed as the upper closing part of this drum 1 here. A peeling disc 13 is arranged in the peeling disc chamber. The peeling disc 13 operates on the principle of a centripetal pump and accordingly conveys the liquid phase(s) L1 or L2 to the outside. However, the liquid outlets from the drum can also be designed in other ways.

Inlet and outlet lines into and out of the drum can be open, semi-closed, hydrohermetic or hermetic (see “Industrial Centrifuges”, Volume II, Chapter 6.9 by Weiner H. Stahl).

In this case, the solids are ejected outwardly from the drum 1 through circumferentially distributed, radially extending outlet openings 14, preferably in the region of the largest radius/circumference of the drum 1.

According to FIG. 1, an optional, hydraulically actuated piston slide 5 is provided for the solids outlet in the lower part 3, by means of which the outlet openings 14 can be opened discontinuously and closed again. The solids outlet can also be designed differently than shown here, for example in the form of outlet nozzles. It may also be possible to dispense with a solids outlet.

Alternatively, the separator could also be designed only for centrifugal separation of two liquids. It could also alternatively be designed for batch operation.

In addition, the centrifuge could also be a solid drum screw centrifuge or decanter centrifuge that has a separator disc pack for further clarification of the liquid phase.

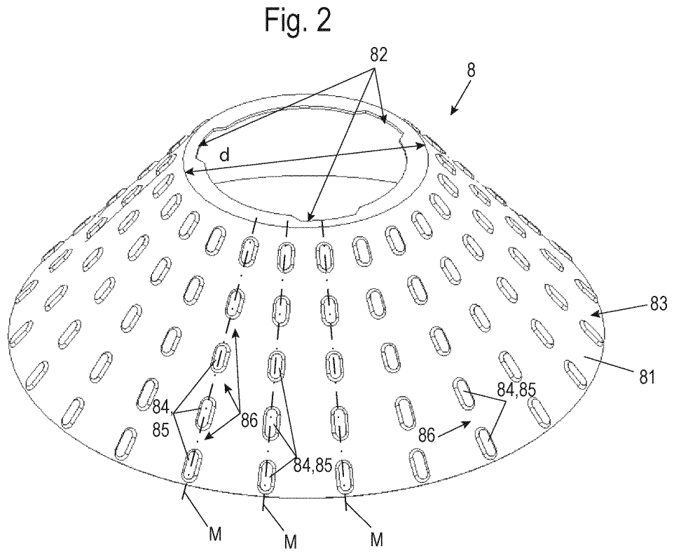

FIG. 2 shows a separator disc 8 for a centrifuge according to the invention. The separator disc 8 has a frustoconical shell-like base body 81. The base body 81 of the separator disc 8 has preferably been produced from a metallic material—preferably steel—by a forming process, in particular preferably by a spinning process. The separator disc 8 can have a driver geometry 82 on a smaller diameter d of the frustoconical base body 81.

The driver geometry 82 is part of a torsionally rigid positive connection between the respective separator disc 8 and the distributor shaft 9 (not shown here, see FIG. 1) geometrically corresponding with the driver geometry 82, which is arranged coaxially to the axis of rotation A within the centrifugal chamber of the centrifuge 1 and onto which several separator discs 8 are placed during the assembly of the drum 1 until an intended separator disc stack 7 has been created.

The separator disc 8 has at least one functional element on its base body 81. According to the invention, it is provided that the at least one functional element is manufactured by an additive manufacturing process. As a result, the at least one functional element can advantageously be freely designed in terms of topology, geometry, and material over a wide range.

A functional element in the sense of the present invention is an element which is associated with the separator disc 8 and fulfills a partial function of the separator disc 8. Partial functions of the separator disc 8 are, for example, keeping distance to an adjacent separator disc 8 in the stack of separator discs 7 so that a gap is formed between the adjacent separator discs 8.

Furthermore, the partial functions include, for example, lipophilicity, i.e., a property promoting good solubility of fats, or hydrophilicity, i.e., a property promoting strong interaction with water. If the base body 81 of the separator disc 8 has areas or layers with lipophilic properties and/or areas or layers with hydrophilic properties, this can advantageously influence the release properties of the separator disc 8 or of the separator disc stack 7, which is composed of corresponding separator discs 8.

In order to fulfill the partial function of “keeping a distance to an adjacent separator disc 8 in the separator disc stack 7 so that a gap is created between the adjacent separator discs 8”, the separator disc 8 in the example of FIG. 2 has several spacers 84 on an outer surface 83 of the base body 81. These have been created on the provided base body in an additive manufacturing process, in particular in 3-D printing.

The spacers 84 can advantageously be firmly joined to the base body 81 without gaps by this manufacturing method, so that additional joining of the spacers 84 on the base body 81—in particular also such joining to fill gaps between the spacer 84 and the base body 81—can advantageously be omitted.

The spacers 84 may alternatively also be arranged on an inner surface of the base body 81. In another alternative embodiment, the spacers 84 can be arranged both on the outer surface 83 and on the inner surface of the base body 81. If they are printed on the outer surface 83 and on the inner surface, the separator disc 8 adjacent to it in the separator disc stack 7 can be designed without spacers 84. This advantageously reduces the manufacturing effort for the separator discs 8 and thus lowers the costs.

The spacers 84 can be made of a metallic material or a non-metallic material —such as plastic or ceramic. In this way, for example, the partial function of thermal or electrical insulation of two adjacent separator discs 8 can be realized.

The cross-sectional geometry of the spacers 84 can be freely selected by the additive manufacturing process for producing the spacers 84 provided in accordance with the invention. In this respect, the cross-sectional geometry of the spacers 84 can be, for example, trapezoidal rectangular, rectangular with rounded corners, semi-elliptical or semi-oval, or have another advantageous geometry. The cross-sectional geometry of the spacers 84 may also be asymmetrical.

In the exemplary embodiment of FIG. 2, the spacers 84 are designed in the form of elongated tabs 85, each arranged symmetrically with respect to and along a generatrix M or parallel to the generatrix. In a view perpendicular to the outer surface 83, each tab 85 is designed as an oval consisting of two semicircles and a rectangle with parallel sides —thus similar to a stadium running track. The respective tab 85 here has a trapezoidal cross-section in the region of the rectangle and a half frustoconical cross-section in the region of each of the semicircles.

The term “generatrix” means such a line, each of which is erected perpendicularly on two parallel tangents, wherein the tangents are respectively tangent to the small diameter d of a frustum and to a large diameter of the frustum.

The tabs 85 are distributed here by way of example in a uniform pitch on the circumference of the base body 81, here on the outer surface 83 of the base body 81. The spacers 84 may also be arranged in non-uniform pitch or variable pitch or in repeating—i.e., regular-pitch patterns or in non-repeating—i.e., irregular-pitch patterns on the circumference of the base body 81.

The tabs 85 are spaced apart here by spaces/gaps 86 of equal length between the tabs 85. The gaps 86 can also be of different lengths and/or different sizes from tab 85 to tab 85. The tabs 85, which are arranged symmetrically with respect to and along or parallel to a generatrix M, can also vary in length.

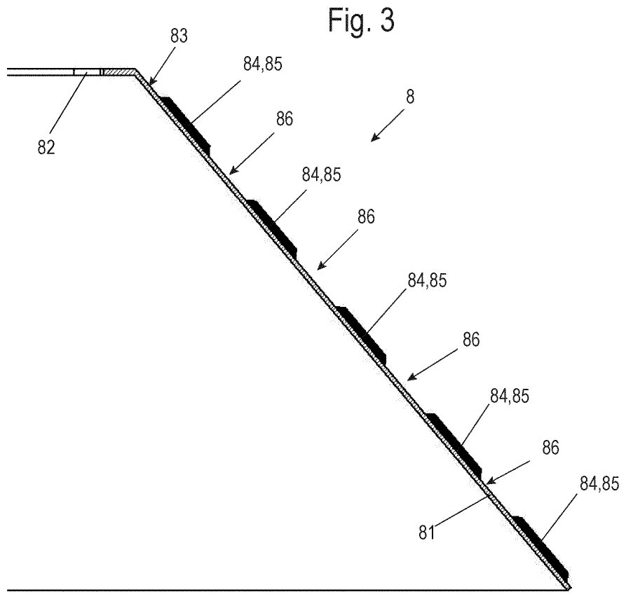

FIG. 3 shows a half sectional view of the separator disc 8 from FIG. 2. The base body 81, to whose outer surface 83 the spacers 84 or, in this case, the tabs 85 are applied, is clearly visible.

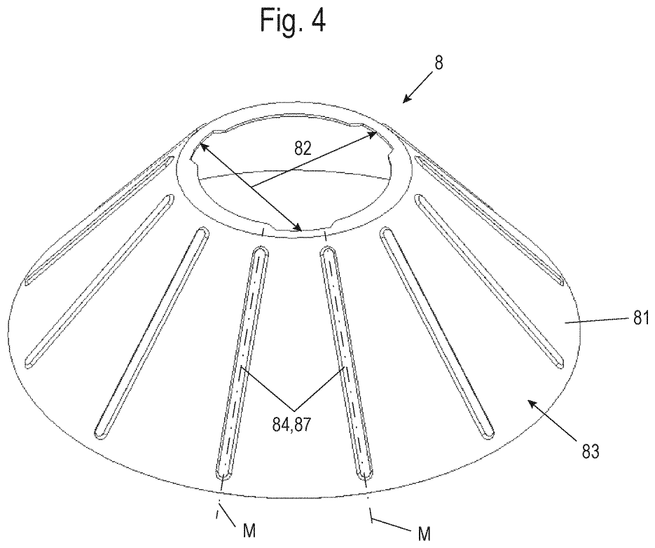

FIG. 4 shows a further exemplary embodiment of the spacers 84. In the exemplary embodiment of FIG. 2, the spacers 84 are designed in the form of linear tabs 87 arranged symmetrically with respect to and along a generatrix M or parallel to the generatrix, where the tabs 87 are distributed here in an exemplary uniform pitch on the circumference of the base body 81, in this case on the outer surface 83 of the base body 81. Each individual tab 87 has here a continuous length corresponding approximately to the length of a generatrix M on the outer surface 83 of the frustoconical base body 81.

A trapezoidal geometry was also selected here as the cross-sectional geometry of the tabs 87, with the ends having a half frustoconical cross-section, analogous to the design shown in FIG. 2.

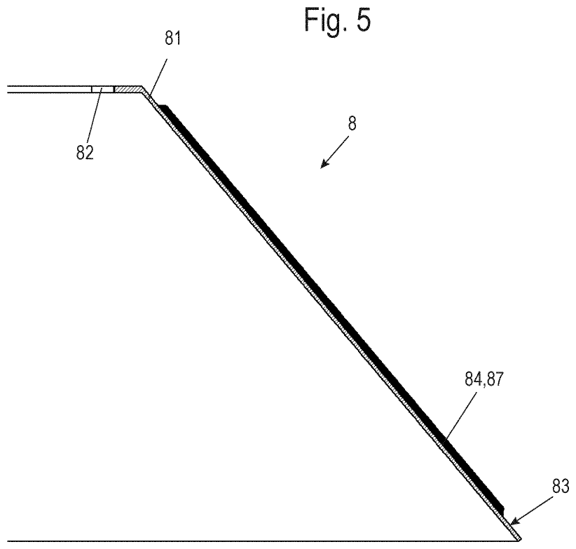

FIG. 5 shows a half sectional view of the separator disc 8 from FIG. 4. The base body 81, to whose outer surface 83 the spacers 84 or, in this case, the tabs 87 are applied, is clearly visible.

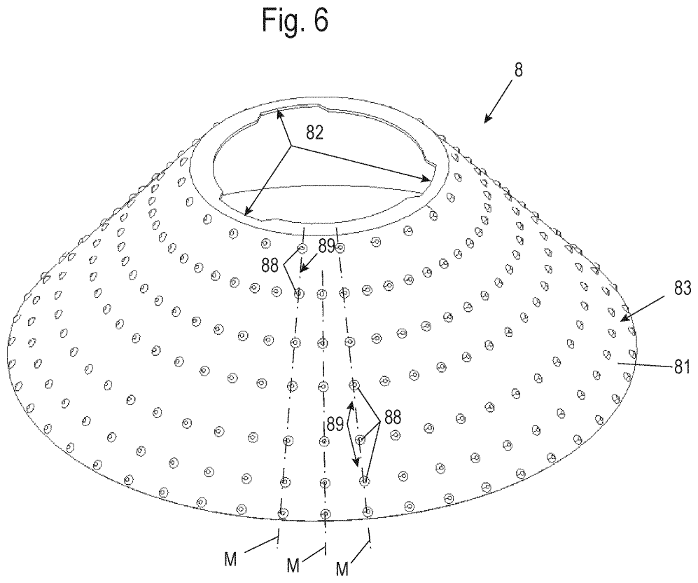

FIG. 6 shows another exemplary embodiment of the spacers 84. In the exemplary embodiment of FIG. 2, the spacers 84 are designed in the form of point-shaped or more precisely circular tabs 88 arranged symmetrically with respect to and along a generatrix M or generatrix-parallel, wherein the tabs 88 are distributed here, by way of example, in a uniform pitch on the circumference of the base body 81, in this case on the outer surface 83 of the base body 81.

The tabs 88 are spaced apart here by respective spaces/gaps 89 of equal length between the tabs 88. The gaps 89 can also be of different lengths and/or different sizes from tab 88 to tab 88.

A frustoconical geometry was selected here as the cross-sectional geometry of the tabs 88.

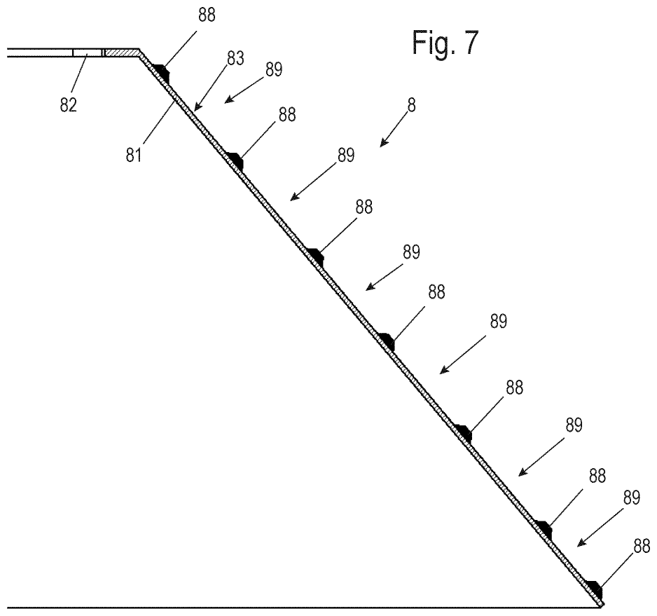

FIG. 7 shows a half sectional view of the separator disc 8 from FIG. 6. The base body 81, to whose outer surface 83 the spacers 84 or, in this case, the tabs 87 are applied, is clearly visible.

The geometry of the spacers 84 on a separator disc can vary. Accordingly, differently shaped spacers 84 can also be arranged on a separator disc 8, in deviation from the examples in FIGS. 2 to 7.

With regard to their topology, the spacers 84 can also—deviating from the examples of FIGS. 2 to 7—each extend along a uniform or respectively different or pattern-arranged, mathematically describable curve(s). The dimensions—i.e., for example, width and length—of the spacers 84 on a separator disc 8 can also vary.

Likewise, the cross-sectional geometry of the spacers 84 may vary. Conceivable cross-sectional geometries include triangles, trapeziums, circles, circular rings, rectangles, ellipses, ovals, or any other geometry that can be described mathematically. The cross-sectional geometry of the spacers 84 may also be asymmetrical or vary from spacer 84 to spacer 84 on a separator disc 8.

Production by an additive manufacturing process, particularly preferably by a 3D printing process, can be carried out very flexibly using an industrial robot on whose “tool center point” a 3D printing unit is mounted. This means that even large separator discs 8 can be advantageously printed with spacers 84, since the traversability of the 3D printing unit is limited only by the reach of the robot used.

The outer side 83 between the spacers 84 or the inner side or the inner side between the spacers 84 —if the inner side also has spacers 84—of the respective separator disc 8 can optionally be provided with further functional elements by the additive manufacturing process. For example, certain areas of the separator disc 8 can be printed with a layer of a hydrophilic material and other areas can be printed with a layer of a lipophilic material. In the separation of milk, for example, this has the effect that the sliding properties of cream or skim milk can be advantageously influenced in a targeted manner.

If the separator discs 8 adjacent in a separator disc stack 7 are electrically insulated from each other by printed spacers 84 made of an electrically insulating material, the separator discs 8 adjacent in a separator disc stack 7 can be provided with different electrical potentials, whereby the separating property of the separator disc stack 7 can also be advantageously influenced.

The layers can be made of a metallic material or a non-metallic material such as plastic or ceramic.

The following method is given for manufacturing a separator disc 8 according to the invention:

First, a blank for the base body 81 of the separator disc 8 is provided, as well as a forming machine and a unit for carrying out an additive manufacturing process. In a second method step, the blank is formed into the base body 81 on the forming machine. In a final method step, the at least one functional element is produced by the 3D printing unit.

Advantageously, the forming machine is a spinning machine. This provides a proven manufacturing process for the base body 81.

A 3D printing unit is provided as a unit for carrying out an additive manufacturing process. It is advantageous if the 3D printing unit is mounted on an industrial robot.

The blank of the base body 81 is made of a metallic material, preferably steel. This ensures that the separator disc 8 permanently withstands the forces acting on it during operation of the centrifuge 2.

The at least one functional element is made of a metallic or non-metallic material. This results in an advantageously high degree of design freedom for the respective functional element.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

1 Drum
2 Centrifuge
3 Lower part
4 Upper part
5 Piston slide
6 Drum interior
7 Separator disc stack
8 Separator disc
81 Base body
82 Driver geometry
83 Outer surface
84 Spacer
85 Tab
86 Gap
87 Tab
88 Tab
89 Gap
9 Distributor shaft
10 Distributor
11 Feed pipe
12 Distributor channel
13 Peeling disc
14 Outlet opening
15 Peeling disc chamber
A Rotation axis
d Diameter
L1, L2 Liquid phases

1-26. (canceled)

27. A separator disc for a centrifuge, the separator disc comprising:
a frustoconical shell-like base body created from a blank in a forming process and having an inner surface and an outer surface, wherein at least one functional element is applied to the inner or outer surface, wherein the at least one functional element is produced by an additive manufacturing process, and
wherein the separator disc is configured to be arranged in a separator disc stack in a drum interior of a drum of the centrifuge for separating a mixture of substances.

28. The separator disc of claim 27, wherein the additive manufacturing process is a 3D printing process.

29. The separator disc of claim 27, wherein the at least one functional element has at least two spacers.

30. The separator disc of claim 29, wherein the at least two spacers are connected to the base body without a gap.

31. The separator disc of claim 29, wherein the at least two spacers are arranged on the outer or inner surface of the base body.

32. The separator disc of claim 29, wherein a geometry of the at least two spacers on the separator disc varies so that not all spacers of the at least two spacers on the separator disc have a same geometry.

33. The separator disc of claim 29, wherein length and width dimensions of the at least two spacers on a separator disc vary.

34. The separator disc of claim 29, wherein the at least two spacers have a form of respective elongated tabs arranged symmetrically with respect to and along a generatrix or parallel to the generatrix.

35. The separator disc of claim 29, wherein the at least two spacers have a form of point-shaped or circular tabs.

36. The separator disc of claim 35, wherein the elongated tabs are spaced apart by gaps of equal length between each of the elongated tabs.

37. The separator disc of claim 36, wherein the elongated tabs or the gaps are of different lengths, or the gaps are of different sizes from tab to tab.

38. The separator disc of claim 29, wherein the at least one functional element is a hydrophilic layer.

39. The separator disc of claim 29, wherein the at least one functional element is a lipophilic layer.

40. The separator disc of claim 27, wherein the separator disc has, at a smaller diameter of the frustoconical base body, a driver geometry geometrically corresponding with a distributor shaft of the centrifuge.

41. A centrifuge, comprising:
a drum having a drum interior; and
a separator disc stack arranged in the drum interior, wherein the separator disc stack comprises a plurality of separator discs stacked on one another, wherein each of the plurality of separator discs comprises
a frustoconical shell-like base body created from a blank in a forming process and having an inner surface and an outer surface, wherein at least one functional element is applied to the inner or outer surface, wherein the at least one functional element is produced by an additive manufacturing process.

42. A method for producing a separator disc, the method comprising:
a) providing a blank for a base body of the separator disc, a forming machine, and a unit for performing an additive manufacturing process;
b) forming the blank into the base body on the forming machine, wherein the base body is a frustoconical shell-like base body having an inner surface and an outer surface;
c) producing at least one functional element on the interior or exterior surface of the frustoconical shell-like base body by the 3D printing unit.

43. The method of claim 42, wherein the forming machine is a spinning machine.

44. The method of claim 43, wherein the unit for performing the additive manufacturing process is a 3D printing unit.

45. The method of claim 44, wherein the 3D printing unit is mounted to a tool center point of an industrial robot.

46. The method of claim 42, wherein the at least one functional element is made of a metallic or non-metallic material.
